(19) United States
(12) Patent Application Publication
(10) Pub. No.: US 2026/0120211 A1
(43) Pub. Date: Apr. 30, 2026

(54) APPARATUS AND METHOD FOR PROVIDING BOOK SERVICE BASED ON BOOK IMAGE

(71) Applicant: GROWV EDU. CORP., Seoul (KR)

(72) Inventors: Cheol Woo PARK, Incheon (KR); Sung Kyu CHUN, Seoul (KR)

(73) Assignee: GROWV EDU. CORP., Seoul (KR)

(21) Appl. No.: 19/476,500

(22) PCT Filed: Feb. 16, 2024
(86) PCT No.: PCT/KR2024/095256

§ 371 Date: Oct. 17, 2025

(30) Foreign Application Priority Data
May 15, 2023 (KR) 10-2023-0062552

(51) Int. Cl. G06Q 50/20; G06Q 20/12; G06Q 30/06; G06V 10/12

(52) U.S. Cl. CPC G06Q 50/20; G06Q 20/123; G06Q 30/06; G06V 10/12

(57) ABSTRACT

Disclosed are an apparatus and method for providing a book service based on a book image. The apparatus for providing a book service based on a book image includes an acquisition unit configured to acquire a book image from a user; a determination unit configured to determine whether the user is a learning service user using a pre-designated learning service and determine whether the user has a purchase-related history associated with a target book corresponding to the book image at a pre-designated shopping mall; and a provision unit configured to provide a book service associated with the target book when it is determined that the purchase-related history exists.

### TECHNICAL FIELD

The present invention relates to an apparatus and method for providing a book service based on a book image. More particularly, the present invention relates to an apparatus and method for providing a book service based on a book image, which enable a user who utilizes a specific learning service to perform authentication by recognizing at least a portion of a book through a terminal, and provide the user with digital content associated with the corresponding book when it is determined that the user has a purchase-related history associated with the recognized book in a pre-designated shopping mall, and thus only subscribers who have purchased genuine books are allowed to play and access the digital content, thereby promoting the growth of the publishing industry, enhancing the protection of copyright holders'rights, and establishing a new publishing ecosystem.

### BACKGROUND OF THE INVENTION

Books are said to be nourishment for the mind that enriches human life. Reading a book is more than just accumulating knowledge or gathering information, and it can be a form of play for children and a healthy and beneficial hobby for people of all ages, so that interest in books is growing day by day.

Books are also widely used as educational and learning materials, and the genres of books are diverse and include poetry, fairy tales, short stories, essays, and self-development.

The current book market offers physical books, along with e-books, video, and audio services utilizing those books, however, existing publishers do not create digital content utilizing popular new releases or bestsellers and distribute them online. Conventionally, such digital content has merely been distributed as supplementary materials, such as CDs, attached to the book itself. This is because online distribution of digital content utilizing the corresponding books may negatively affect and hinder the sales of the physical books. On the other hand, consumers have a high demand for digital content for the most popular and best-selling books, but since digital content for these books has not been provided in the past, there is an imbalance between supply and demand in the book market.

In addition, the current paper book (physical book) publishing industry is generally in a transitional period, and with the emergence and growth of secondhand trading platforms, the percentage of first-time purchases of genuine books is steadily decreasing, and due to various social issues, the overall population of paper book readers has been shrinking, leading to a bleak outlook for the industry.

Children's paper books, which are mainly fairy tales, still show relatively higher utilization compared to books read by other age groups such as teenagers or adults, since many parents wish to read books to their children. Paper books for children offer a variety of age-appropriate topics (learning content) based on the child's age (in months), and as the child grows, the child must be educated with books suitable for the child's current age, and thus the applicable period during which a specific book can be used for learning is relatively short, and for this reason, most parents tend to purchase second-hand books or borrow books from libraries rather than purchasing genuine books for their children's education, and as a result, the purchase rate of genuine books is significantly low. In addition, with the development of information and communication technologies, e-book services for children are currently being provided, and educational video content services are also already actively provided in the present book market, and therefore, even without purchasing paper books (particularly genuine paper books), learning and education can be carried out by using e-books and video content, and accordingly, the perception of the necessity of purchasing paper books has been gradually decreasing.

In addition, in terms of convenience, e-books have the advantage of being easily and quickly accessible anytime and anywhere, compared to paper books, and therefore, even among teenagers and adult users, only a small number of people read paper books, while the majority tend to read books in the form of e-books.

For the above reasons, the future of the paper book publishing industry is increasingly uncertain.

As such, the current book market is largely dominated by the second-hand trading market and the e-book related market, and consequently, the share of the genuine physical book market has been declining, which makes it difficult to protect the rights of copyright holders and further weakens the publishing industry.

Accordingly, there is an urgent need for the development of a technology that can revitalize the currently stagnant paper book publishing market (particularly the genuine paper book market). There is also a necessity to establish a new type of publishing ecosystem that enables authors, as copyright holders of books, to receive proper protection of their rights.

The technology forming the background of the present invention is disclosed in Korean Laid-open Patent Publication No. 10-2012-0012871.

### DETAILED DESCRIPTION OF THE INVENTION

### Problem to be Solved by the Invention

The present invention is directed to providing an apparatus and method for providing a book service based on a book image, which allow only subscribers who have purchased genuine books to reproduce specific content (digital content), thereby increasing the ratio of genuine book purchasers compared to second-hand book users and extending the retention period of books by subscribers, and through this, promoting the growth of the publishing industry, enhancing the protection of copyright holders'rights, and enabling a business model combining digital devices and paper books to create a new publishing ecosystem.

The present invention is also directed to providing an apparatus and method for providing a book service based on a book image, which allow digital content utilizing corresponding physical books to be used (e.g., to be available for a fee) for newly released books and best-selling books that have high demand in the book market, thereby correcting the imbalance of supply and demand in the conventional book market and enabling the digital content of the most demanded new and best-selling books to be sold without affecting the sales of the corresponding physical books.

The present invention is also directed to providing an apparatus and method for providing a book service based on book images, which enables a user to utilize various services (digital content associated with a target book) provided in association with a specific book, thereby not only enabling the user to acquire/learn the content written in the book, but also increasing interest and immersion by allowing the user to access the content associated with the book in more diverse manners.

The present invention is also directed to providing an apparatus and method for providing a book service based on a book image, which provide, when it is determined that a user has a purchase history or a payment history for a specific book, book services (i.e., digital content associated with the target book) associated with the corresponding book to the user to be available for use, and particularly allows the user to conveniently access and utilize such services without complexity or inconvenience. However, the technical problems to be achieved by the embodiments of the present invention are not limited to the aforementioned technical problems, and other technical problems may also exist.

### Solution to the Problem

According to an aspect of the present invention, there is provided an apparatus for providing a book service based on a book image, which includes an acquisition unit configured to acquire a book image from a user; a determination unit configured to determine whether the user is a learning service user using a pre-designated learning service and determine whether the user has a purchase-related history associated with a target book corresponding to the book image at a pre-designated shopping mall; and a provision unit configured to provide a book service associated with the target book when it is determined that the purchase-related history exists.

In addition, the determination unit may determine that a user using a monthly subscription service provided free of charge or for a fee by the apparatus is the learning service user.

In addition, the purchase-related history may be a history of the user purchasing or renting the target book from the pre-designated shopping mall.

In addition, the acquisition unit may acquire, upon detection in a shooting mode, the book image within a display image by analyzing the display image shown on a screen.

In addition, the book image may be an image acquired by recognizing at least a portion of the target book.

In addition, the book service may be a service that provides, for a fee, target book-related digital content previously generated in association with the target book, and the target book-related digital content may include content associated with at least one of video, audio, and activities associated with the target book.

According to another aspect of the present invention, there is provided a method of providing a book service based on a book image, which includes acquiring, by an acquisition unit, a book image from a user; determining, by a determination unit, whether the user is a learning service user using a pre-designated learning service and determining whether the user has a purchase-related history associated with a target book corresponding to the book image at a pre-designated shopping mall; and providing, by a provision unit, a book service associated with the target book when it is determined that the purchase-related history exists.

The above-described technical solutions are merely exemplary and should not be construed as intending to limit the present invention. In addition to the exemplary embodiments described above, additional embodiments of the invention may exist in the drawings and the detailed description of the invention.

### Effects of the Invention

According to the apparatus and method for providing a book service based on a book image, only subscribers who have purchased genuine products (genuine books) from a designated shopping mall can reproduce specific content (digital content) when reproducing the specific content, thereby increasing a ratio of purchasers of genuine books compared to secondhand transactions of the books and extending a retention period of books of the subscribers, and thereby enabling the growth of the publishing industry and the protection of the rights of copyright holders to be enhanced, while creating a new publishing ecosystem through a business model that combines digital devices and paper books.

Also, according to the apparatus and method for providing a book service based on a book image, digital content using the corresponding books (physical books) can be used for new releases and bestseller books with high demand in the book market, thereby correcting the imbalance of demand and supply in the conventional book market and enabling the digital content of the most demanded new releases and bestseller books to be effectively sold/rented without affecting the sales of the corresponding physical books.

Also, according to the apparatus and method for providing a book service based on a book image, the user can use various services (digital content associated with the target book) provided in association with a specific book (a book, a target book), and through this, the user can acquire/learn the content written in the book and access the content associated with the corresponding book in more diverse manners, thereby increasing interest and immersion.

Also, according to the apparatus and method for providing a book service based on a book image, when it is determined that the user has a book purchase history or a charging history of having purchased the corresponding book (the target book) with respect to a specific book (the target book), a book service (that is, digital content associated with the target book) associated with the corresponding book can be provided to the user so that the user can use it, and particularly, when using such services, the user can conveniently access and use the corresponding services without complication or inconvenience.

However, the effects that can be obtained in the present invention are not limited to the effects described above, and other effects may also exist.

### BRIEF DESCRIPTION OF DRAWINGS

FIG. 1 is a diagram illustrating a schematic configuration of an apparatus for providing a book service based on a book image according to an embodiment of the present invention.

FIG. 2 is a diagram illustrating a schematic configuration of a system for providing a book service based on a book image including an apparatus for providing a book service based on a book image according to an embodiment of the present invention.

FIG. 3 is a diagram illustrating book images acquired by an apparatus for providing a book service based on a book image according to an embodiment of the present invention.

FIG. 4 is a diagram illustrating a comparison storage icon provided by a control unit of an apparatus for providing a book service based on a book image according to embodiments of the present invention.

FIG. 5 is a flowchart illustrating a method of providing a book service based on a book image according to an embodiment of the present invention.

### MODE FOR CARRYING OUT THE INVENTION

Hereinafter, embodiments of the present invention will be described in detail with reference to the accompanying drawings so that those of ordinary skill in the technical field to which the invention pertains can readily carry out the invention. However, the present invention may be implemented in various different forms and is not limited to the embodiments described herein. In the drawings, portions not related to the description for clearly explaining the present invention are omitted, and like reference numerals denote like components throughout the specification.

Throughout this specification, when a certain component is described as being “connected to” or “coupled to” another component, this should be understood to mean not only being “directly connected,” but also being “electrically connected” or “indirectly connected” with still another element interposed therebetween.

Throughout this specification, when a member is described as being “on,” “over,” or “above,” or “under,” “beneath,” or “below” another member, it includes not only cases where the one member is in contact with the other member, but also cases where another member is present between the two members.

Throughout this specification, when a part is described as “including” a certain component, it means that, unless expressly stated to the contrary, other components are not excluded and may be further included.

Throughout this specification, some of the operations or functions described as being performed by a terminal, device, or apparatus may instead be performed by a server connected to the terminal, device, or apparatus. Likewise, some of the operations or functions described as being performed by a server may be performed by a terminal, device, or apparatus connected to the server.

Throughout this specification, the term “at least one of” may be defined to include both the singular and the plural. Even in the absence of the term “at least one of,” each component may exist in singular or plural form, and it will be apparent that it can mean singular or plural. In addition, whether each component is provided in singular or plural form may vary depending on the embodiment.

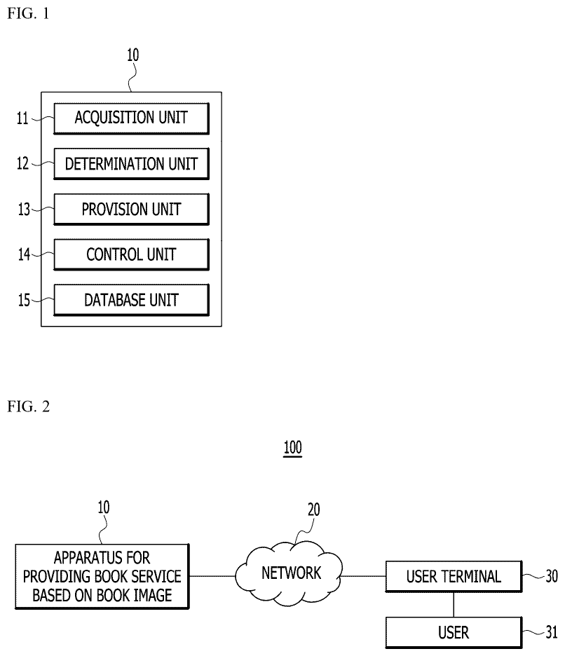

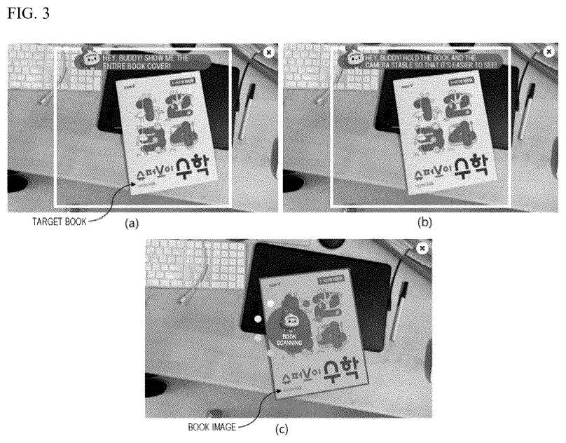

FIG. 1 is a diagram illustrating a schematic configuration of a book image-based book service providing apparatus 10 according to an embodiment of the present invention. FIG. 2 is a diagram illustrating a schematic configuration of a system 100 for providing a book service based on a book image including the book image-based book service providing apparatus 10 according to an embodiment of the present invention. FIG. 3 is a diagram illustrating a book image acquired by the book image-based book service providing apparatus 10 according to an embodiment of the present invention.

Hereinafter, for convenience of description, the book image-based book service providing apparatus 10 according to an embodiment of the present invention will be referred to as the apparatus 10, and the book image-based book service providing system 100 according to an embodiment of the present invention will be referred to as the system 100.

Referring to FIGS. 1 to 3, the system 100 may include the apparatus 10 and a user terminal 30.

The apparatus 10 is a book image-based book service providing apparatus and may be an apparatus capable of providing a user 31 with various book services associated with book images recognized based on book image recognition. The apparatus 10 may be otherwise referred to as an apparatus for providing a book service based on book image recognition.

The service provided by the apparatus 10 is a book service based on a book image, which, for convenience of description, may be referred to as the service, and may also be referred to by other terms such as a Groby service. This service may be a monthly subscription service provided to users for a fee or free of charge. In addition, the term “pre-designated learning service” in the present invention may mean the service (monthly subscription service) provided by the apparatus 10.

The apparatus 10 enables the user 31, who has purchased or rented a book provided exclusively in a pre-designated shopping mall, to perform authentication by identifying at least a portion of the book through the user terminal 30 possessed by the user, and thereafter, when it is determined that there exists a user's purchase or rental history (i.e., a purchase-related history to be described later) in the pre-designated shopping mall with respect to the identified book, the apparatus 10 may provide the user with digital content associated with the corresponding book. Here, the designated shopping mall can be understood as a concept including the company's own shopping mall operated by a manager (or a learning service provider to which the manager belongs) who manages the apparatus 10, and an affiliated shopping mall affiliated with the manager (or the learning service provider).

In describing the present invention, a book may be referred to by other terms, such as a publication. Furthermore, books provided for sale or rental at the designated shopping mall in the present invention may be referred to as designated books, which may refer to genuine books or physical books (genuine physical books) available only at the designated shopping mall. In addition, books (physical books) identified (identified by scanning or photographing books) by a user through the camera of the user terminal 30 may be referred to as target books. In the present invention, the user may acquire a book image corresponding to the target book by identifying the target book through the user terminal 30.

The books (physical books) considered in the present invention, particularly books for which book services (e.g., digital content) are provided by a provision unit 13, are books (designated books) offered by a designated shopping mall, and these books may, for example, be newly released books or best-selling books that are in high demand in the book market. However, the scope of the present invention is not limited thereto, and the books considered in the present invention may include various kinds of books, including general books as well as newly released books and best-selling books.

It may be preferable that the books considered in the present invention be newly released books and best-selling books. Accordingly, the present invention (i.e., the apparatus 10 and the system 100) is directed to providing a technology that allows digital content utilizing the corresponding book (physical book) to be used (e.g. used for a fee) with respect to newly released books and best-selling books that are in high demand in the book market, thereby correcting the imbalance of supply and demand in the conventional book market and enabling the digital content of the most demanded newly released books and best-selling books to be sold without affecting the sales of the corresponding physical book.

In addition, the pre-designated shopping mall considered in the present invention may include, as mentioned above, a company's own shopping mall (exclusive online or offline shopping mall) directly managed and operated by an administrator (or a learning service provider to which the administrator belongs) who manages and operates the apparatus 10, and may further include an affiliated shopping mall (affiliated online or offline shopping mall) affiliated with the administrator (or the learning service provider). In other words, the pre-designated shopping mall may include, for example, a shopping mall directly operated by the administrator or indirectly operated through an affiliation. The number of pre-designated shopping malls considered in the present invention may be one or more.

Accordingly, the designated book considered in the present invention is a book (genuine book, genuine physical book) provided only in the pre-designated shopping mall, and specifically, it does not necessarily mean a book provided only in a company's own shopping mall but may mean a book provided in either a company shopping mall or an affiliated shopping mall.

In addition, the pre-designated shopping mall may be a shopping mall that provides at least one book (physical book, genuine book) for purchase or rental by a user. That is, the pre-designated shopping mall may be a shopping mall that provides at least one book to a user through sale or rental. Hereinafter, for convenience of description, the pre-designated shopping mall will be described as being capable of providing a plurality of books (i.e., providing the books through sale or rental).

The plurality of books provided in the pre-designated shopping mall may be books that are not provided (through sale or rental) in shopping malls other than the pre-designated shopping mall. That is, the plurality of books may, for example, be books provided (provided through sale or rental) only in the pre-designated shopping mall (exclusive books of the company), and thus the plurality of books may be otherwise referred to as a plurality of designated books in the present invention. Each of the plurality of books may refer to a physical book.

The user terminal 30 may be a terminal possessed by the user 31 who uses the apparatus 10. The user 31 may purchase or rent at least one book among the plurality of books provided in the pre-designated shopping mall (particularly provided through sale or rental). After purchasing or renting at least one of the plurality of books provided in the pre-designated shopping mall, the user 31 may, for example, identify (scan or photograph) the corresponding book using a camera of the user terminal 30 possessed by the user, and in response to the identification, may receive a book service associated with the identified book (i.e., a target book) from the apparatus 10. Here, the book service may be, for example, a paid service provided for a fee. When the user 31 wishes to use the book service provided from the apparatus 10, the user 31 may, for example, use the service by paying an amount corresponding to the fee. Here, the book identified by the user 31 through the camera of the user terminal 30 may be referred to as the target book in the present invention as described above. The user 31 may be any person regardless of age or gender. The user 31 may also be otherwise referred to as a subscriber, customer, or member.

In this case, the book service associated with the target book may be a service that provides, for a fee, digital content associated with the target book previously generated in association with the target book to the user. Here, the digital content associated with the target book may include content related to at least one of video, audio, and activities associated with the target book. As such, the book service associated with the target book may be an additional service provided for a fee in association with the target book (physical book).

For example, when a user identifies a target book, which is a specific book (specific physical book), through the camera of the user terminal 30, the apparatus 10 may acquire a book image of the target book from the user 31, and thereafter, the apparatus 10 determines whether the user is a learning service user who uses a pre-designated learning service, and here, when it is determined that the user is a learning service user, the apparatus 10 determines whether there exists a purchase-related history, that is, a history in which the user has purchased or rented the target book in the pre-designated shopping mall, and thereafter, when it is determined that a purchase-related history exists, the apparatus 10 may provide the user with a book service associated with the target book, in other words, the apparatus 10 may allow the user to use the book service by providing the book service to the user (enabling the book service to be reproduced on the user terminal).

In this case, in a case in which the book image is acquired, when the apparatus 10 detects that the user is logged in to the apparatus 10 (this means that the user has already registered as a member and is in a logged-in state), the apparatus 10 may determine that the user is a learning service user who uses the pre-designated learning service (i.e., the service, a monthly subscription service). Thereafter, when the apparatus 10 determines that the user is a learning service user, the apparatus 10 may, for example, based on login information of the logged-in user, determine whether a purchase-related history exists, that is, a history in which the user has purchased or rented the target book (i.e., the designated book corresponding to the target book) in the pre-designated shopping mall. Here, when it is determined that a purchase-related history exists, the apparatus 10 may provide the user with the book service associated with the target book, which may be a service (e.g., a paid service) provided by the apparatus 10.

In this case, when it is determined that a purchase-related history does not exist, the apparatus 10 may provide, on a screen (a screen of the user terminal), a payment induction page to induce the user to purchase or rent the target book (physical book). Here, the payment induction page may include predetermined sales price information, which is information on an amount to be paid when the user wishes to purchase the target book, and include predetermined usage fee information (or rental fee information), which is information on an amount to be paid when the user wishes to rent the target book. Accordingly, the user may purchase or rent the target book (physical book) by paying (settling) the amount (payment amount) corresponding to the predetermined sales price information or the predetermined usage fee information included in the payment induction page provided by the apparatus 10.

For example, when the user 31 pays an amount corresponding to the predetermined usage fee information, the user may rent the target book provided by the pre-designated shopping mall, and in this case, the user may rent and use the target book only during a predetermined usage period corresponding to the predetermined usage fee information. Here, the predetermined usage fee information (or rental fee information) may also be referred to as information on a predetermined amount previously set for the purchase of a usage right (license) associated with renting the target book.

The user terminal 30 possessed by the user 31 may include, for example, any type of wired or wireless communication device such as a personal communication system (PCS) terminal, a Global System for Mobile Communications (GSM) terminal, a personal digital cellular (PDC) terminal, a personal handy-phone system (PHS) terminal, a personal digital assistant (PDA), an International Mobile Telecommunications (IMT)-2000 terminal, a code division multiple access (CDMA)-2000 terminal, a wideband code division multiple access (W-CDMA) terminal, a wireless broadband Internet (WiBro) terminal, a smartphone, a smart pad, a tablet PC, a notebook, a wearable device, or a desktop PC, however, the user terminal 30 is not limited thereto.

The apparatus 10 may, for example, be linked with the user terminal 30 through a network 20 to transmit and receive data. The network 20 may include, for example, a Third Generation Partnership Project (3GPP) network, a Long Term Evolution (LTE) network, a World Interoperability for Microwave Access (WiMAX) network, the Internet, a local area network (LAN), a wireless local area network (WLAN), a wide area network (WAN), a personal area network (PAN), a Bluetooth network, a near field communication (NFC) network, a satellite broadcasting network, an analog broadcasting network, or a digital multimedia broadcasting (DMB) network, however, the network 20 is not limited thereto and may include various wired and wireless communication networks.

The apparatus 10 may be an apparatus or a server that provides a web page, an app page, a program, or an application associated with providing a book image-based book service. The program or application associated with providing the book image-based book service by the apparatus 10 may, for convenience of description, be referred to as the program or the app. The user 31 may receive and use the book image-based book service through the program or the app provided by the apparatus 10. In addition, the user 31 may, for example, use the service by installing or not installing the program or the app, and may also use the service by registering as a member (or logging in) or not after installing the program or the app. In the present invention, it may be preferable that the user 31 install the app or the program and register as a member (or logs in) before or after installation to use the service, however, the invention is not limited thereto, and it may also be possible to use the service without installation or member registration (or login).

The apparatus 10 may, for example, be an apparatus implemented in the form of a program or an application installed in the user terminal 30, and in other words, a method of providing a book service based on a book image, which is performed through the apparatus 10, may be implemented in the form of a program or an application and may be provided to the user 31 through the user terminal 30. In this manner, when the apparatus 10 is implemented in the form of the program or the application installed in the user terminal 30, the apparatus 10 illustrated in FIG. 1 may, for example, be included within the user terminal 30.

However, the invention is not limited thereto, and in another example, as illustrated in FIG. 2, the apparatus 10 may be provided in the form of a server capable of transmitting and receiving data to and from the user terminal 30 through the network 20, and in this case, the apparatus 10 provided in the form of the server may control the operation (e.g., screen display) of the user terminal 30 that has accessed the app or the program provided by the apparatus 10.

In addition, the apparatus 10 may provide a book image-based book service providing platform (the platform) by providing the app or the program.

Hereinafter, in describing the present invention, for convenience of description, an example will be given mainly with reference to FIG. 1 in which the apparatus 10 is included in the user terminal 30. However, this is merely one example for aiding the understanding of the present invention, and is not limiting, and as described above, the apparatus 10 may also be implemented in the form of a server, and therefore, the following description of the apparatus 10 may be applied identically or correspondingly even when the apparatus 10 is implemented in the form of a server. Hereinafter, the apparatus 10 will be described in more detail.

When the book image is acquired from the user, the apparatus 10 may determine whether the user is a learning service user, and when the user is a learning service user, the apparatus 10 may determine (confirm) whether there exists a purchase-related history in which the user has purchased or rented the target book corresponding to the book image in the pre-designated shopping mall. In this case, depending on whether a purchase-related history exists, when it is determined that a purchase-related history exists, the apparatus 10 may provide (reproduce), on the screen (the screen of the user terminal), a book service associated with the target book, that is, a service for providing target book-related digital content for a fee, thereby enabling the user to use the service, and on the other hand, when it is determined that a purchase-related history does not exist, the apparatus 10 may provide, on the screen, a payment induction page so that the user can purchase or rent the target book (physical book) (i.e., to induce the user to perform payment for purchasing or renting the physical book of the target book).

The apparatus 10 and the system 100, in providing the service, may operate an online or offline shopping mall (i.e., a pre-designated shopping mall) for purchasing or renting physical books, so that a user, who is a customer having purchased or rented a physical book (genuine book) from the pre-designated shopping mall, identifies (scans or photographs) an image of a book cover and pages (i.e., book pages constituting the book) of the corresponding book (target book) through a camera of a terminal (user terminal), such as a tablet or a smart device, and next, the apparatus 10 and the system 100 may distinguish and recognize only the book purchased or rented from the pre-designated shopping mall (i.e., the company shopping mall and the affiliated shopping mall), and in this case, only when the book corresponding to the image (book image) recognized by the user's camera is the book (i.e., a designated book) provided by the pre-designated shopping mall while the user is a learning service user, the apparatus 10 and the system 100 may identify and call the digital content of the corresponding book, which is provided for a fee, and provide the user with the digital content so that the user can use the digital content. In this case, when it is determined that the user is a learning service user and that a purchase-related history exists, the apparatus 10 may extract (call), for example, designated book-related digital content of the designated book (i.e., the same designated book corresponding to the same book as the target book) corresponding to the target book from among a plurality of pieces of designated book-related digital content for each of a plurality of designated books stored in advance in a database unit 15, thereby providing the extracted designated book-related digital content to the user as a book service associated with the target book (particularly, target book-related digital content).

The apparatus 10, in providing the book service associated with the target book (i.e., target book-related digital content) to the user, may prevent the user from receiving the book service associated with the target book without performing an authentication process that requires, from the user, recognition of the cover (book cover) of the designated book or the image of the book page within the designated book using the camera. That is, the book service associated with the target book provided to the user by the apparatus 10 (which may be at least one piece of designated book-related digital content among the plurality of pieces of designated book-related digital content within the database 15) is a paid service, and may be configured to prevent access and reproduction of the digital content (e.g., not provide the digital content to the user) without authentication of the user via the cover or interior image of the target book which is the designated book.

The apparatus 10 may call, from a platform (particularly, from the database unit 15), the corresponding book-related digital content provided for a fee, and provide the called book-related digital content to the user so that the book-related digital content is reproduced on the screen (the user terminal), only when it is authenticated that the user is determined to be a learning service user and that there exists a purchase-related history in which the user has purchased or rented the target book from the pre-designated shopping mall. In this manner, the apparatus 10 may allow authentication of ownership of the book (designated book) to be achieved only through performing an authentication process in which, after the user has actually purchased or rented the corresponding book from the pre-designated shopping mall, the user identifies a portion of the cover or the page of the book using the camera of the user terminal, and as a result, the apparatus 10 may promote the sales of the physical book (physical book corresponding to designated book) and may allow the digital content of the physical book (designated book) to be sold to the user by providing the book service, which is a paid service, while not causing a decrease in the sales of physical books. In the present invention, for example, an administrator managing the apparatus 10 may be an administrator who produces and/or distributes books (designated books).

The administrator of the apparatus 10 may be a user who performs management so that physical books can be sold or rented in the pre-designated shopping mall (that is, the company shopping mall and the affiliated shopping mall). In addition, the administrator may be a user who operates, through the apparatus 10, a content platform for providing, for a fee, digital content associated with the physical books (designated books). The apparatus 10 may provide the digital content associated with the physical book (designated book) to various digital devices (terminals), such as a tablet PC or a smartphone, so that the user can use the digital content. In the present invention, the user terminal 30 may, for example, be referred to by other terms such as a digital terminal.

Specifically, referring to FIGS. 1 to 3, the apparatus 10 may include an acquisition unit 11, a determination unit 12, a provision unit 13, a control unit 14, and a database unit 15.

The acquisition unit 11 may acquire a book image from the user 31. In this case, the book image acquired by the acquisition unit 11 may be a book image of a book (designated book) provided (through sale or rental) by a pre-designated shopping mall or may be a book image of a book not provided by the pre-designated shopping mall.

The user 31 may identify (photograph or scan) a specific book (specific physical book) using a camera of a user terminal 30, and accordingly, the acquisition unit 11 may acquire, from the user terminal 30, a book image generated by the user 31 identifying the specific book using the user terminal 30. In this case, the book (that is, the specific book identified by the user using the camera) corresponding to the book image acquired by the acquisition unit 11 may be referred to as a target book in the present invention.

The acquisition unit 11, upon detection in a photographing mode, may acquire the book image of the target book within a displayed image by analyzing (image-analyzing) the displayed image shown on the screen. The book image acquired by the acquisition unit 11 may be an image (image associated with the target book) acquired by the user 31 identifying (scanning or photographing) at least a portion of the target book using the camera of the user terminal 30. In particular, the book image acquired by the acquisition unit 11 may be an image (image associated with the target book) acquired by identifying at least a portion of the cover of the target book or at least a portion of book pages constituting the target book. Here, the book cover may include a front cover, a back cover, and a side cover of the target book. The target book, as described above, may be a physical book.

The target book (i.e., the physical book) for which the user performs image recognition (photographing, scanning) using the camera of the user terminal may be a book that the user has already purchased or rented (completed) from a designated shopping mall, or a book that the user has not yet purchased or rented from the designated shopping mall.

The user 31 may turn ON the camera of the user terminal 30 possessed by the user 31 so that the user terminal 30 enters a photographing mode (i.e., allows the camera to enter an activated state). Thereafter, the user 31 may identify (scan or photograph) the target book using the user terminal 30 in the photographing mode (i.e., the user terminal in which the camera is in the ON state) so that the target book is displayed (exposed, shown) on the screen of the user terminal 30.

When it is detected that the user 31 has identified (scanned or photographed) the target book (physical book) using the user terminal 30 in the photographing mode, as illustrated in FIG. 3 (a), the acquisition unit 11 may perform image analysis in real time on the displayed image shown on the screen (the screen of the user terminal) to determine (in real time) whether the book image of the target book is included in the displayed image. In this case, when it is determined that the displayed image includes the book image of the target book as illustrated in FIG. 3 (c), the acquisition unit 11 may acquire the book image by extracting the book image of the target book from the displayed image. Here, while performing the image analysis, various image analysis techniques (e.g., object recognition techniques, etc.) previously known or developed in the future may be applied.

When the book image of the target book is acquired by the acquisition unit 11, the determination unit 12 may determine whether the user is a predetermined learning service user using the pre-designated learning service, and may determine whether there exists a purchase-related history of the user associated with the target book corresponding to the book image in the pre-designated shopping mall. In particular, when it is determined that the user is a predetermined learning service user, the determination unit 12 may subsequently determine whether a purchase-related history exists.

Here, the pre-designated learning service may be a monthly subscription service (the service) provided free of charge or for a fee by the apparatus 10. Therefore, the determination unit 12 may determine that the user using the monthly subscription service provided free of charge or for a fee by the apparatus 10 is a learning service user.

In this case, since the monthly subscription service (the service) is a service provided to a user who has completed membership registration or logged in to the apparatus 10, when the user is logged in to the apparatus 10, the determination unit 12 may recognize that the user is a user (member) who has registered as a member of the apparatus 10, and accordingly determine that the user is a learning service user. When the user is not logged in to the apparatus 10, the determination unit 12 may provide a login induction page on the screen of the user terminal 30 that allows the user to log in or register as a member and then log in, thereby inducing the user to use the service after logging in.

Here, the pre-designated shopping mall may include, as previously mentioned, a company's own shopping mall (exclusive online/offline shopping mall) operated by the apparatus 10 or an administrator managing the apparatus 10, and affiliated affiliate shopping malls (affiliated online/offline shopping malls).

The pre-designated shopping mall may be a shopping mall that provides services for selling or renting a plurality of books. In this case, the plurality of books provided (sold or rented) by the pre-designated shopping mall may be referred to as “a plurality of designated books,” as previously mentioned.

Book information (i.e., a plurality of pieces of book information) associated with the plurality of books (the plurality of designated books) provided (i.e., provided through sale or rental) by the pre-designated shopping mall may be stored (registered) in advance by the administrator in the database unit 15. The book information, which is information about the book (designated book), may include, for example, a captured image of the designated book and designated book-related digital content generated (produced) in association with the designated book. That is, in the database unit 15, as the book information of the designated book, the captured image of the designated book and the designated book-related digital content may be stored in association with each other. In other words, the database unit 15 may include book information for each of the plurality of designated books, and the book information for each of the plurality of designated books may include the captured book image for each of the plurality of designated books (particularly, at least one captured book image for each of the plurality of designated books) and designated book-related digital content for each of the plurality of designated books.

In addition, the book information may further include at least one of a book name (title), publisher information, sales price information, usage fee information, and book introduction information (e.g., table of contents information, brief introduction information, etc.) of the designated book.

Here, the captured book image may be at least one captured book image associated with the designated book (that is, a captured designated book image), which is generated by photographing at least a portion of the cover (the entire area) of the designated book, and at least a portion of book pages within the designated book constituting the designated book. In addition, the designated book-related digital content may be additional service-related content provided for a fee in association with the designated book, and may include at least one of designated book-related video content, audio content, and activity content.

The plurality of pieces of book information, which are book information of the plurality of designated books stored in advance in the database unit 15, may be information stored by being uploaded by the administrator managing the apparatus 10. Here, the administrator may be, for example, any of the following: i) a user (a publisher-affiliated user) affiliated with a publisher, who supplies, sells, or publishes a book (designated book); ii) a user (e.g., an individual user) who is not affiliated with a publisher but directly supplies, sells, or publishes a book (designated book); and iii) a user (an intermediary) who receives a book from a publisher and performs mediation (sale, provision) so that a user (customer) can purchase or rent the book (designated book). In addition, the administrator may be a user associated with selling or renting the designated book in the pre-designated shopping mall so that the designated book is sold or rented in the pre-designated shopping mall.

The administrator may upload the book information associated with the designated book by using the terminal possessed by the administrator, and the uploaded book information may be stored (registered) in the database unit 15.

In addition, the plurality of pieces of book information stored in the database unit 15 may be information about books (designated books) of a plurality of genres. That is, the book information about each of the designated books of a plurality of genres may be stored in the database unit 15. Here, the plurality of genres (i.e., types of genres) of the designated books may include education, poetry, fairy tales, short stories, essays, and self-development, but are not limited thereto, and various genres of books may be considered.

In addition, the determination unit 12, after determining that the user is a learning service user, may determine whether there exists a purchase-related history of the user associated with the target book in the pre-designated shopping mall. In this case, the purchase-related history may be a purchase-or rental-related history of the user in the pre-designated shopping mall in association with the target book recognized by the user terminal 30, and may be a history in which the user has purchased or rented the target book (that is, the target book corresponding to the book image acquired by the acquisition unit 11) in the pre-designated shopping mall. In other words, the purchase-related history may be a book purchase history in which the user has purchased the target book in the pre-designated shopping mall, or a charging history in which the user was charged to rent the target book in the pre-designated shopping mall.

In this case, in order to determine whether the purchase-related history exists, the determination unit 12 may, for example, preferentially determine (identify) whether the target book corresponding to the book image acquired by the acquisition unit 11 is the designated book provided by the pre-designated shopping mall, based on the book information (i.e., the plurality of pieces of book information) about the plurality of designated books stored in advance in the database unit 15. For example, when the target book is the designated book, the determination unit 12 may determine whether a purchase-related history exists, and when the target book is not the designated book, the determination unit 12 may, for example, perform control so that no service is provided without determining whether a purchase-related history exists, or so that a notification message indicating that the book is not a book for which the book service is provided (that is, the target book of the book service) is provided to the user terminal 30.

As a specific example, in order to determine whether the target book is the designated book, when the book image of the target book is acquired by the acquisition unit 11, the determination unit 12 may subsequently analyze, through image comparison analysis, whether a captured book image matching the book image of the target book exists among the plurality of captured book images (at least one captured book image for each of the plurality of designated books) included in the plurality of pieces of designated book information stored in advance in the database unit 15, and in this case, when it is analyzed that a captured book image matching the book image of the target book exists (that is, exists in the database unit 15), it may be determined, as a result, that the target book is the designated book (that is, the target book is determined to be the designated book provided by the pre-designated shopping mall).

When it is analyzed that a captured book image matching the book image of the target book does not exist in the database unit 15 as the analysis result, the determination unit 12 may determine, as a result, that the target book is not the designated book (that is, the target book is determined not to be the designated book provided by the pre-designated shopping mall).

Meanwhile, for example, each of the plurality of designated books stored in advance in the database unit 15 may be a single book provided (sold or rented) as one individual book or may be a set of books provided (sold or rented) in a form in which two or more books are configured as one bundle (one set). That is, the set of books may be a collection in which a plurality of independent books are gathered as one sales unit and may otherwise be referred to by terms such as “book set.”

The determination unit 12 may, for example, perform a similarity comparison between the captured book image for each of the plurality of designated books stored in advance in the database unit 15 and the book image of the target book acquired by the acquisition unit 11, and based on the result of the similarity comparison, when at least one captured book image among the captured book images for each of the plurality of designated books has a similarity with the book image acquired by the acquisition unit 11 that is equal to or greater than a predetermined similarity value (e.g., 90%), it may be determined that the target book corresponding to the acquired book image is the designated book.

Accordingly, the determination unit 12 may determine whether the target book is the designated book provided for sale or rental in the pre-designated shopping mall (i.e., whether the target book is the designated book) by comparing the similarity (matching degree) between the captured book image for each of the plurality of designated books stored in advance in the database unit 15 and the book image acquired by the acquisition unit 11. In this case, in the similarity comparison between the two images (i.e., the captured book image and the book image acquired by the acquisition unit 11), various similarity analysis techniques (in particular, similarity analysis techniques targeting images) previously known or developed in the future may be applied.

The provision unit 13 may provide the book service associated with the target book when it is determined by the determination unit 12 that a purchase-related history exists. In particular, the provision unit 13 may provide the book service associated with the target book to the user only when it is determined by the determination unit 12 that the user is a learning service user, that the target book is the designated book, and that a purchase-related history in which the user has purchased or rented the target book in the pre-designated shopping mall exists.

That is, when the acquisition unit 11 acquires the book image as the user identifies (scans or photographs) the target book using the user terminal 30, the provision unit 13 may determine whether the user who has identified the target book is a learning service user using the pre-designated learning service (i.e., whether the user is a learning service user who has already registered as a member in the apparatus 10 and is using the service which is a monthly subscription service), and next, when it is determined that the user is a learning service user, the provision unit 13 may then determine whether a purchase-related history in which the user has purchased or rented the target book in the pre-designated shopping mall exists, and may provide the book service associated with the target book to the user only when it is determined that a purchase-related history exists.

In this case, the monthly subscription service may be a paid service or a free service. In addition, in the present invention, the learning service user is a user who uses the service and may otherwise be referred to by terms such as a subscriber.

The book service provided by the provision unit 13 may be a service for providing, for a fee, digital content associated with the target book previously generated (produced) in association with the target book as described above. Here, the digital content associated with the target book may include content associated with at least one of video, audio, and activities (reading activities) associated with the target book.

That is, the provision unit 13 may provide, to the user 31, as a book service (an additional service, a paid service) associated with the target book, digital content associated with the target book provided for a fee (that is, digital content associated with the target book including at least one of video content, audio content, and activity content associated with the target book), only when the user is a learning service user and a purchase-related history exists.

In this case, the digital content associated with the target book corresponding to the book service associated with the target book provided by the provision unit 13 to the user (or to the user terminal) may be designated book-related digital content of the designated book corresponding to the target book (that is, the same designated book corresponding to the same book as the target book) among the digital content associated with the designated book for each of the plurality of designated books stored in advance in the database unit 15.

Here, the video content may be video content (e.g., educational video content) previously produced in association with the target book (or the corresponding designated book), which may be content produced to include only video (images), or content produced to include both video and sound (audio). The audio content may be audio content (e.g., educational audio content) previously produced in association with the target book (or the corresponding designated book), which may be content produced to include only sound (audio) without video (images). The activity content may be reading activity content (e.g., reading activity induction content) previously produced to induce the performance (execution) of reading activities in association with the target book (or the corresponding designated book), which may be content produced to include at least one of video (images) and sound (audio).

Accordingly, the book service associated with the target book provided by the provision unit 13 (that is, the digital content associated with the target book provided for a fee by the provision unit 13 in association with the book service) may be a book service provided only to a user who is a learning service user, who has actually purchased or rented a book (a physical book designated as the designated book) provided (sold or rented) by the pre-designated shopping mall, and who thereafter performs (completes) an authentication process of identifying (scanning or photographing) at least a portion of the cover or the book pages of the book purchased or rented at the designated shopping mall using the camera of the user terminal 30. That is, the book service associated with the target book provided by the provision unit 13 may be a book service provided only to a user who has a purchase-related history in the designated shopping mall, is a learning service user using the service, and has completed an authentication process (a camera recognition-based authentication process) of identifying at least a portion of the cover or the pages of the book purchased or rented from the designated shopping mall using the camera of the user terminal 30.

The provision unit 13 may ensure that the book service associated with the target book is not provided to users corresponding to at least one of the following cases: i) no purchase-related history of the user exists; ii) a purchase-related history of the user exists (that is, the user has purchased or rented the target book from the pre-designated shopping mall), but the authentication process of using the camera of the user terminal 30 to identify the purchased or rented target book (that is, the designated book) is not performed, or the user is not a learning service user; and iii) the target book corresponding to the book image acquired by the acquisition unit is determined not to be the designated book (i.e., the target book recognized through the camera of the user is not a book provided by the designated shopping mall).

The determination unit 12 may, for example, when determining whether a purchase-related history exists, collect and analyze shopping mall-usage history data of the user in the pre-designated shopping mall based on login information of the user, and determine whether a purchase-related history of the user (i.e., a history of purchasing or renting the target book) exists in the user's collected shopping mall-usage history data, and thereafter, when it is determined by the determination unit 12 that the user has a purchase-related history in association with the target book, the provision unit 13 may recognize (determine) that the user's purchase-related history in association with the target book already existed in the past at the time the book image was acquired by the acquisition unit 11, and may subsequently provide (reproduce), on a screen (e.g., the screen of the user's terminal), at least one piece of video content, audio content, and activity content associated with the target book as the book service associated with the target book.

On the other hand, when it is determined by the determination unit 12 that a purchase-related history in association with the target book does not exist, the provision unit 13 may recognize (determine) that the user's purchase-related history in association with the target book had never existed in the past at the time the book image was acquired by the acquisition unit 11, and may subsequently provide, on the screen (screen of the user terminal), the aforementioned payment induction page so that the user 31 may purchase or rent the target book.

The provision unit 13, when it is determined that the user is a learning service user and that a purchase-related history exists, may provide the user with the book service by allowing the book service to be reproduced on the user terminal, and when it is determined that a purchase-related history does not exist, the provision unit 13 may provide a payment induction page on the screen of the user terminal so that the user can use the book service after performing payment on the payment induction page.

Accordingly, the provision unit 13, in providing the user with the book service associated with the target book, may be configured such that the book service associated with the target book (that is, the book service for providing, for a fee, the digital content associated with the target book) is provided to the corresponding user only in a case where: i) through determination of whether the user is a learning service user, it is determined (confirmed) that the user who performed identification (scanning or photographing) of the target book is a registered user (member) of the apparatus 10 (particularly, the program or the application of the apparatus 10), and is determined (confirmed) to be a user who uses, for a fee or for free of charge, the service (that is, the monthly subscription service, the Groby service) provided by the apparatus 10 (that is, a service user); and ii) through determination of the existence of the purchase-related history, it is determined that the user has the history of purchasing or renting the designated book (particularly, a genuine book, a genuine designated book) that is sold only in the pre-designated shopping mall (that is, it is determined that the user is a user who has purchased a genuine book).

The apparatus 10 may, by providing the book service in the above-described manner, be set/limited such that only the user (subscriber) who has purchased the genuine book can reproduce specific content (digital content) provided by the apparatus 10, thereby extending the retention period of the subscriber's book, and as a result, enhancing the growth of the publishing industry and protecting the rights of copyright holders. That is, the apparatus 10 may, when it is determined that a specific user is a registered user of the apparatus 10 who is receiving the service, and is also a user who has purchased or rented the designated book (a genuine physical book) provided by the pre-designated shopping mall directly operated by or affiliated with the administrator of the apparatus 10, provide the book service (digital content associated with the target book) associated with the target book (that is, the designated book) to the user terminal 30 in response to the identification when the user identifies the designated book (genuine physical book) using the camera of the user terminal 30.

Only for users receiving the service, the apparatus 10 may provide the book service associated with the designated book (the target book) only when the user has purchased the designated book, which is the genuine book, from the pre-designated shopping mall, thereby enabling the creation of a new publishing ecosystem through the provision (implementation) of a combined business model of digital devices and paper books. That is, the apparatus 10 may provide an environment of a new publishing ecosystem in which a technology of providing digital content online through digital devices such as a PC or a smartphone and a technology of providing a physical book, which is a paper book, offline are organically combined.

The control unit 14 may control the operation of each component in the apparatus 10. In addition, the control unit 14 may control the operation of the user terminal 30 (e.g., a screen display operation).

The database unit 15 may store (register) the book information associated with the plurality of designated books (that is, the plurality of pieces of book information) as described above, and may store various information (data) considered in the apparatus 10.

Meanwhile, FIG. 2 illustrates a block diagram when the apparatus 10 is implemented in the form of a server. In FIG. 2, the apparatus 10 is merely illustrated as being linked with the user terminal 30 through the network 20 within the system 100, but is not limited thereto. Although not illustrated in the drawings, the system 100 may further include an administrator terminal possessed by an administrator. In such a case, the apparatus 10 may be linked with each of the user terminal 30 and the administrator terminal through the network 20 to transmit and receive data.

In addition, in FIG. 2, one user terminal 30 is exemplified, but this is merely for convenience of description, and the system 100 may include a plurality of user terminals possessed by a plurality of users. In this case, the user terminal 30 may be any one of the plurality of user terminals, and even if omitted hereinafter, the description of the user terminal 30 (or the user) may be equally applied to the description of each of the plurality of user terminals (or the plurality of users), and vice versa. The apparatus 10 may control the operation (e.g., a screen display operation) of each terminal connected to the apparatus 10 through the network 20.

FIG. 3 illustrates a process in which the acquisition unit 11 acquires a book image of a target book by the user 31 identifying (scanning or photographing) the target book using the camera of the user terminal 30.

As described above, the user 31 may turn ON (activate) the camera of the user terminal 30 to allow the camera to enter a photographing mode and may then identify (scan or photograph) the target book (a specific physical book) using the camera so that an image (a book image) of the target book is displayed on a screen. That is, in order to acquire the book image, recognition of the book image of the target book may be initiated (performed) through a camera stream (a real-time stream) in the user terminal 30.

In this case, when it is detected that the photographing mode is activated, the acquisition unit 11 may display photographing guidance phrase information in a certain area of the screen (the screen of the user terminal). Here, the photographing guidance phrase information may, for example, be as shown in FIG. 3 (a), such as “Hey, buddy! Show me the entire book cover!”

In addition, when it is detected that the photographing mode is activated, the acquisition unit 11 may display recognition rate improvement-guidance phrase information in a certain area of the screen so that the book image of the target book can be more accurately recognized (that is, in order to improve the recognition rate of the book image). Here, the recognition rate improvement guidance phrase information may, for example, be as shown in FIG. 3 (b), such as “Hey, buddy! Hold the book and the camera steady so that it's easier to see!” When it is detected in the photographing mode that at least a portion of a cover area (the entire area of the book cover) of the target book is recognized (that is, when it is detected that at least a portion of the area is displayed (exposed) on the screen), the acquisition unit 11 may, for example, display (provide) the recognition rate improvement-guidance phrase information in a certain area of the screen.

The recognition rate improvement-guidance phrase information may be provided on the screen as needed or may not be provided. That is, the provision of the recognition rate improvement-guidance phrase information may be optional, and whether the recognition rate improvement-guidance phrase information is provided (displayed) may be determined by an administrator who manages the apparatus 10.

In addition, the names of the above-described photographing guidance phrase information and recognition rate improvement-guidance phrase information, and the examples of the corresponding phrase information, are merely examples for facilitating the understanding of the present invention, and are not limiting, and may be variously set and changed by the administrator who manages the apparatus 10.

When the user 31 identifies (scans or photographs) the target book using the user terminal 30 in the photographing mode, the acquisition unit 11 may perform real-time image recognition and real-time analysis (image analysis) on a display image displayed on the screen in the photographing mode to determine (in real time) whether the display image includes the book image of the target book. In this case, when it is analyzed through real-time image analysis that the display image includes the book image of the target book, the acquisition unit 11 may acquire the book image by extracting the book image of the target book included in the display image, as illustrated in FIG. 3 (c).

When it is determined (identified, detected) by the acquisition unit 11 that the book image of the target book is included, the determination unit 12 may subsequently determine whether there exists, among the plurality of pieces of book information stored in advance in the database unit 15 (particularly, among the captured book images for each of the plurality of designated books), a captured book image having a similarity with the book image acquired by the acquisition unit 11 that is equal to or greater than a predetermined similarity value (e.g., 90%), and in this case, when it is determined that there exists a captured book image having a similarity equal to or greater than the predetermined similarity value, the target book may be determined to be a designated book provided by the pre-designated shopping mall (that is, determined to be the designated book). That is, the determination unit 12 may, for example, determine whether there exists, among the plurality of designated books stored in advance in the database unit 15, a designated book having a captured book image with high similarity (matching degree) to the book image of the target book identified through real-time image recognition or analysis, thereby determining whether the target book is the designated book.

The database unit 15 may store the captured book image for each of the plurality of designated books in association with the corresponding designated book. That is, the database unit 15 may store, as book information, captured book images acquired by photographing at least a portion of the book cover or book pages of each designated book to be subject to image recognition in advance, in association with designated book-related digital content corresponding to the captured book image. Here, the captured book image of each of the plurality of designated books stored in the database unit 15 may, for example, be a pre-processed captured book image. The database unit 15 may also be referred to by the term “target set,” which means a set generated by pre-processing images (captured book images) of each designated book to be recognized in advance so that the pre-processed images may serve as recognition results.

In addition, for example, when the determination unit 12 determines that the target book is the designated book, the determination unit 12 may determine whether the purchase-related history (that is, a book purchase history or a charging history) of the user associated with the target book exists, based on login information of the user. For example, the determination unit 12 may determine whether the purchase-related history of the user exists by collecting and analyzing shopping mall usage history data of the user in the pre-designated shopping mall, based on login information of a logged-in user. In this case, when performing the analysis of the collected shopping mall usage history data of the user, the determination unit 12 may perform, for example, i) a first determination process of determining whether the user's purchase-related history corresponding to the same single book as the target book exists in the user's shopping mall usage history data in association with the target book, and ii) when the target book is a book composed of a set of books, a second determination process of determining whether the user's purchase-related history corresponding to the set book (that is, a target book-related set book) configured to include the target book exists in the user's shopping mall usage history data.

In this case, when it is determined (detected) in at least one of the first determination process and the second determination process that a purchase-related history of the user exists, the determination unit 12 may determine that a purchase-related history of the user associated with the target book exists as a result. When it is determined in both the first determination process and the second determination process that a purchase-related history of the user does not exist, the determination unit 12 may determine that a purchase-related history of the user associated with the target book does not exist as a result.

Thereafter, when the determination unit 12 determines, for example, that a purchase-related history of the user exists, the provision unit 13 may provide (display), on the screen, an additional service associated with the target book that is the designated book, as the book service associated with the target book. Here, the book service associated with the target book (additional service) may include designated book-related digital content, which includes at least one of target book (or the designated book corresponding thereto)-related video content, audio content, and activity (reading activity) content, generated (produced) in advance in association with the target book, as described above. In the present invention, for example, three types of book services provided in association with the target book (that is, video, audio, and activity) are illustrated as an example, but this is merely an example to aid understanding of the present invention, and is not limiting, and the number and kinds of types of book services applied in the apparatus 10 may be variously set and changed by the administrator who manages the apparatus 10.

When the determination unit 12 determines that a purchase-related history of the user does not exist, the provision unit 13 may provide, on the screen (the screen of the user terminal), a payment induction page for inducing a payment for purchasing the target book or a payment for renting the target book.

In this case, the provision unit 13 may provide the payment induction page as needed, or may not provide it. That is, the provision of the payment induction page may be optional, and whether to provide the payment induction page may be determined by the administrator who manages the apparatus 10.

As described above, the apparatus 10 may provide a book service (book-related additional service) linkage technology based on image recognition of the target book. In addition, the apparatus 10 may also provide the following functions.

For example, when it is determined that a purchase-related history of the user does not exist and the payment guidance page is provided to the user terminal, and when it is detected that the user has paid (made a payment) for an amount corresponding to predetermined sales price information or predetermined usage fee information within the payment guidance page, the provision unit 13 may thereafter provide the target book to the user as a book purchased by the user, or provide the target book to the user as a book rented by the user.

That is, when it is detected that the user has paid (made a payment) for the amount corresponding to the predetermined sales price information or predetermined usage fee information in the payment guidance page, the provision unit 13 may thereafter cause the target book to be delivered to a registered address of the user 31. In this case, when the user 31, after receiving delivery of the target book (that is, the target book purchased or rented by the user), identifies (scans or photographs) the book image of the delivered target book using the camera of the user terminal 30, the provision unit 13 may, in response thereto, provide the user with the book service associated with the target book, which is a service provided for a fee.

For example, the sales price information may be information on the sales price of the target book that the user 31 has to pay in order to purchase the target book, and may be set to, for example, 9,800 won, 10,500 won, and the like. In addition, for example, the usage fee information may be information on the usage fee (rental fee) that the user 31 has to pay in order to use the target book for a predetermined usage period, and may be set to, for example, a first amount per day (or per 24 hours), a second amount per week, a third amount per month, a fourth amount per year, and the like.

In this case, after the payment induction page is provided on the screen, when a payment execution signal indicating that the user 31 wishes to pay (make a payment of) the payment amount corresponding to the predetermined sales price information or the predetermined usage fee information within the payment induction page is detected, a payment may be made for the payment amount (that is, the amount corresponding to the predetermined sales price information or the predetermined usage fee information) through a predefined payment processing procedure at the user terminal 30 in response to the detection.

Here, the predefined payment processing procedure may be a process in which, when it is detected that the user 31 has previously stored a plurality of credit cards having the name of the user (the user's own name) in the user terminal 30, monthly performance record data of each of the plurality of user's credit cards previously stored by the user is acquired based on the detection time point at which the payment execution signal is detected, and that, in consideration of the acquired monthly performance record data, one credit card of the plurality of user's credit cards that has the smallest value of the shortfall performance amount at the detection time point is selected as a payment-processing target credit card, and that a payment process for the payment amount is performed by using the selected payment-processing target credit card.

Here, the monthly performance record data may be data related to the performance of the current month in association with the credit card having the name of the user. The monthly performance record data may include, for example, performance achievement threshold information serving as a basis for performance achievement, which is set in advance for the credit card of the user by the credit card company of the credit card, and performance fulfillment amount information recorded up to the detection time point (the current time) in the current month by using the credit card of the user. In this case, the shortfall performance amount value for a specific credit card of the user may be information derived by subtracting the performance fulfillment amount information from the performance achievement threshold information of the specific credit card of the user.

For example, three credit cards under the user's name have been previously stored by the user 31, and the provision unit 13, based on the monthly performance record data acquired for each of the three credit cards, derives and identifies the shortfall performance amount value of each credit card, and it is found through the identification that the shortfall performance amount value of the first credit card is “−113,000 won,” the shortfall performance amount value of the second credit card is “−28,000 won,” and the shortfall performance amount value of the third credit card is “+40,000 won.” In such a case, the provision unit 13, during execution of the predefined payment processing procedure, selects the second credit card, which has the smallest shortfall performance amount value among the three credit cards (i.e., the first to third credit cards), as the payment-processing target credit card, and performs payment processing of the payment amount using the selected second credit card. In this case, the credit card having a positive shortfall performance amount value is a credit card for which performance has already been achieved, and therefore may be excluded from selection as the payment-processing target credit card.

The apparatus 10, when the user makes a payment amount through a specific credit card among a plurality of credit cards under the user's name, may allow the payment of the payment amount to be performed preferentially with the credit card having the smallest shortfall performance amount value, thereby providing an environment in which more card benefits can be obtained.

In addition, the control unit 14 may, for example, provide a book search menu in a portion of the screen, and when a click input of the user 31 with respect to the book search menu is made, may display, on the screen (the screen of the user terminal), a book search page including a plurality of pieces of book information stored in the database unit 15. The user 31 may perform a book search by inputting a keyword of a desired book for which to search (i.e., a keyword associated with genre, book title, publisher, or age, etc.) in the book search page.

When the user 31 inputs a keyword for a book search in the book search page, the control unit 14 may extract, as keyword-matching book information, at least one piece of book information that matches the keyword input by the user 31 among the plurality of pieces of book information registered in advance in the database unit 15, generate a list thereof, and provide the list on the screen. Here, as described above, the database unit 15 may store book information about each of the plurality of genres of books.

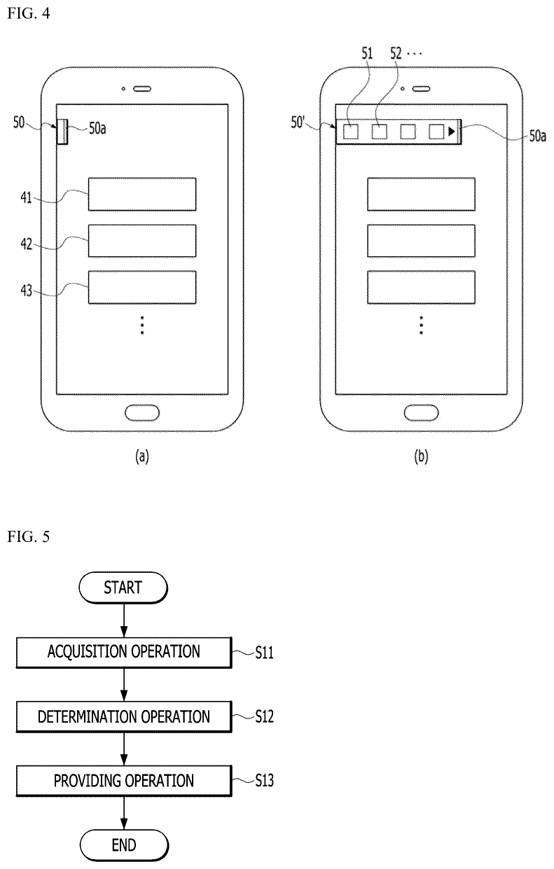

In this case, after the user 31 is provided with a list of the keyword-matching book information from the control unit 14, the user 31 may compare the keyword-matching book information in the provided list with each other and purchase a corresponding book by selecting and making a payment for at least one piece of the keyword-matching book information in the list, and in this case, the control unit 14 may provide, in a portion of the screen (the screen of the user terminal), a comparison storage icon 50 as illustrated in FIG. 4, so that the user 31 can more conveniently perform comparisons between the pieces of book information, and this can be more easily understood with reference to FIG. 4.

FIG. 4 is a diagram illustrating a comparison storage icon 50 provided by the control unit 14 of the apparatus 10 for providing a book service based on a book image according to embodiments of the present invention.

Referring to FIG. 4, when a keyword associated with a desired book to be searched for is input by the user 31 on the book search page, the control unit 14 may extract a plurality of pieces of keyword-matching book information (41, 42, 43, . . . ) among the plurality of pieces of book information stored in advance in the database unit 15 that match the keyword input by the user 31, and may display, on the screen, a list including the extracted plurality of pieces of keyword-matching book information (41, 42, 43, . . . ).

The user 31 may review and compare the information in the list and may purchase a book by performing a payment after selecting one piece of keyword-matching book information that is most preferred among them, and in this case, when finally selecting specific book information that is most preferred, the user may deliberate which information to finally select among the plurality of pieces of keyword-matching book information of interest (interest keyword-matching book information).

In this case, for the convenience of comparison among the plurality of pieces of keyword-matching book information of interest, the control unit 14 may provide a comparison storage icon 50 in a portion of the book search page.

In a case where the user 31 finally selects one piece of keyword-matching book information, for example, first keyword-matching book information 41, as the most preferred among the plurality of pieces of keyword-matching book information 41, 42, 43, . . . in the list, the control unit 14 may allow the user 31, when some of the plurality of pieces of keyword-matching book information (e.g., the first keyword-matching book information and the third keyword-matching book information) are found to be preferable in the process, to temporarily store such preferable keyword-matching book information as the interest keyword-matching book information in the comparison storage icon 50, and to finally select the most preferred keyword-matching book information (e.g., the first keyword-matching book information) while simultaneously viewing and comparing the temporarily stored interest keyword-matching book information and the plurality of pieces of keyword-matching book information 41, 42, 43, . . . on one screen of the user terminal 30.

Specifically, in a case where the user wishes to temporarily store the first keyword-matching book information 41 as the interest keyword-matching book information while reviewing the plurality of pieces of keyword-matching book information 41, 42, 43, . . . in the list, the user 31 may press the first keyword-matching book information 41 for a predetermined time (e.g., 1.5 seconds), and in response thereto, the control unit 14 may temporarily store the first keyword-matching book information 41 in a first temporary storage region 51 among a plurality of empty temporary storage regions 51, 52, . . . within the comparison storage icon 50. Thereafter, when the user 31 wishes to temporarily store the third keyword-matching book information 43 among the plurality of pieces of keyword-matching book information 41, 42, 43, . . . in the list as the interest keyword-matching book information while reviewing the list, the user may press third keyword-matching book information 43 for a predetermined time, and in response thereto, the control unit 14 may temporarily store the third keyword-matching book information 43 in a second temporary storage region 52 within the comparison storage icon 50.

In this case, the comparison storage icon 50 may basically be in a basic state as illustrated in FIG. 4 (a). In this case, when wishing to check the keyword-matching book information temporarily stored by the user as the interest keyword-matching book information, the user 31 may click an expansion button portion 50a within the comparison storage icon 50 in the basic state. In response to the click on the expansion button portion 50a of the user 31, the control unit 14 may cause the comparison storage icon 50 in the basic state to be displayed as an expanded-state comparison storage icon 50′ as illustrated in FIG. 4 (b).

Due to the expanded-state comparison storage icon 50′, the user 31 may identify the keyword-matching book information temporarily stored by the user as the interest keyword-matching book information. That is, in the expanded-state comparison storage icon 50′, the first keyword-matching book information 41 may be displayed (exposed) in the first temporary storage region 51 as the interest keyword-matching book information, and the third keyword-matching book information 43 may be displayed (exposed) in the second temporary storage region 52. In this case, through each temporary storage region within the expanded-state comparison storage icon 50′, for example, a representative photograph of the interest keyword-matching book information associated with the interest keyword-matching book information temporarily stored therein may be displayed (exposed) (that is, for example, in the first temporary storage region 51, a representative photograph of the first keyword-matching book information 41 may be displayed (exposed), and in the second temporary storage region 52, a representative photograph of the third keyword-matching book information 43 may be displayed (exposed)).

Here, the representative photograph of the keyword-matching book information displayed (exposed) in each temporary storage region within the comparison storage icon 50 may be i) automatically set as a thumbnail photograph predetermined by the user who registered the keyword-matching book information in the apparatus 10 (that is, an uploader who uploaded the keyword-matching book information to the apparatus 10, which may be the administrator managing the apparatus 10, or may be one of a plurality of users using the apparatus 10), or ii) set, in a case where a plurality of images are included in the keyword-matching book information, as a photograph of any one image selected by the user 31 among the plurality of images in the keyword-matching book information, or iii) set as a photograph of an image corresponding to a drag area (a rectangular drag area) directly designated by the user 31 to include some of the content desired by the user 31 to be set as the representative photograph among the content of the detailed description information of the keyword-matching book information. In the present invention, it may be more preferable that the representative photograph displayed in each temporary storage region within the comparison storage icon 50 be set in the case of iii) among the above-described three cases, and in a case where a representative photograph set by the user 31 does not exist, it may be preferable that the representative photograph be set in the case of i).

Generally, on conventional sites for product sales and the like, when a user confirmed information on a product registered as interest information, the user had to move to a separate shopping cart page or wish list page to confirm the product registered as the interest information, and therefore, the user could not confirm the interest information together on the screen currently being viewed. In addition, a representative photograph predetermined by the uploader who uploaded the corresponding information was generally displayed as a representative photograph of information stored in a shopping cart or the like, and in such a case, when a plurality of pieces of interest information were stored in the shopping cart or the like due to the user's interest, it was difficult for the user to intuitively confirm what point was interesting about the corresponding information and why the information was designated as the interest information only through the representative photograph, and accordingly, in order to find the reason why a certain point was favored and the information was designated as the interest information, the user had the inconvenience of individually confirming the interest information saved in the wish list again.

In order to solve such conventional problems, the control unit 14 may allow the user 31 to temporarily store some of the plurality of pieces of keyword-matching book information (e.g., the first/third keyword-matching book information) in the temporary storage regions within the comparison storage icon 50, and in this case, as the representative photograph of the keyword-matching book information stored in each temporary storage region, instead of the representative photograph predetermined for the corresponding book information (that is, the representative photograph set in advance by the uploader who uploaded the corresponding book information), a photograph of an image (that is, an image corresponding to the drag area directly designated by drag input by the user 31 among the content of the detailed description information of the keyword-matching book information), which is set through designation of a drag area (direct designation) so that some pieces of content desired by the user 31 are included, may be applied and displayed.

Through this, the apparatus 10, by providing the comparison storage icon 50, may allow the user 31 to intuitively confirm and compare only the images (representative photographs) of the keyword-matching book information of interest, and may allow the user to simultaneously view and compare the information temporarily stored as the interest information (that is, the interest keyword-matching book information) on the current screen where the list is displayed (that is, on the book search page where the plurality of pieces of book information are displayed) without moving to a separate page.

Hereinafter, based on the content described in detail above, the operation flow of the present invention will be briefly described.

FIG. 5 is a flowchart illustrating a method of providing a book service based on a book image according to an embodiment of the present invention.

The method illustrated in FIG. 5 may be performed by the apparatus 10 described above. Therefore, even where description is omitted below, the content described with respect to the apparatus 10 may likewise be applied to the description of the method of providing a book service based on a book image.

Referring to FIG. 5, in operation S11, the acquisition unit may acquire a book image of a target book from the user.

In operation S11, upon detection in a photographing mode, the acquisition unit may acquire the book image within a displayed image by analyzing the displayed image shown on a screen. In addition, the book image may be an image acquired by recognizing at least a portion of the cover of the target book or the book pages constituting the target book.

Next, in operation S12, the determination unit may determine whether the user is a learning service user who uses a designated learning service and may then determine whether there exists a purchase-related history associated with the target book corresponding to the book image in a pre-designated shopping mall.

Next, in operation S13, the provision unit may provide a book service associated with the target book when it is determined that the user is a learning service user and that a purchase-related history exists.

Here, the book service may be a service for providing, for a fee, digital content associated with the target book previously generated in association with the target book. The digital content associated with the target book may include content about at least one of video, audio, and activities (reading activities) associated with the target book.

In the above description, operations S11 to S13 may, according to embodiments of the present invention, be further divided into additional operations or combined into fewer operations. In addition, some operations may be omitted if necessary, and the order of the operations may also be changed.

The method of providing a book service based on a book image according to an embodiment of the present invention may be implemented in the form of program instructions that can be executed through various computer means and may be recorded on a computer-readable medium. The computer-readable medium may include program commands, data files, and data structures, either alone or in combination. The program commands recorded on the medium may be specially designed and configured for the present invention or may be known and available for use by those skilled in the field of computer software. Examples of computer-readable recording media include magnetic media such as hard disks, floppy disks, and magnetic tapes; optical media such as compact disc-read only memories (CD-ROMs) and digital versatile discs (DVDs); magneto-optical media such as floptical disks; and hardware devices such as read-only memories (ROMs), random access memories (RAMs), and flash memories, which are specially configured to store and execute program instructions. Examples of program commands may include not only machine language code generated by a compiler but also high-level language code that can be executed by a computer using an interpreter or the like. The above-described hardware devices may be configured to operate as one or more software modules to perform the operations of the present invention, and vice versa.

In addition, the above-described method of providing a book service based on a book image may also be implemented in the form of a computer program or application executed by a computer and stored in a recording medium.

The foregoing description of the present invention is provided for illustrative purposes only, and those skilled in the art will readily appreciate that modifications to other specific forms can be made without altering the technical spirit or essential characteristics of the present invention. Therefore, the embodiments described above should be understood as illustrative in all respects and not restrictive. For example, components described as single may be implemented in a distributed manner, and similarly, components described as distributed may be implemented in a combined manner.

The scope of the present invention is defined by the following claims rather than the detailed description above, and all modifications or variations derived from the meaning and scope of the claims and their equivalents should be construed as being encompassed within the scope of the present invention.

1. An apparatus for providing a book service based on a book image, the apparatus comprising:
an acquisition unit configured to acquire a book image from a user;
a determination unit configured to determine whether the user is a learning service user using a pre-designated learning service, which is a service provided by the apparatus, based on the user's login information to the apparatus, and determine whether the user has a purchase-related history associated with a target book corresponding to the book image at a pre-designated shopping mall; and
a provision unit configured to provide a book service associated with the target book that is a book provided in the pre-designated shopping mall when it is determined that the purchase-related history exists.

2. The apparatus of claim 1, wherein the determination unit determines that a user using a monthly subscription service provided by the apparatus is the learning service user.

3. The apparatus of claim 1, wherein the purchase-related history is a history of the user purchasing or renting the target book from the pre-designated shopping mall.

4. The apparatus of claim 1, wherein the acquisition unit acquires, upon detection in a shooting mode, the book image within a display image by analyzing the display image shown on a screen.

5. The apparatus of claim 1, wherein the book image is an image acquired by recognizing at least a portion of the target book.

6. The apparatus of claim 1, wherein the book service is a service that provides, for a fee, target book-related digital content previously generated in association with the target book, and
the target book-related digital content includes content associated with at least one of video, audio, and activities associated with the target book.

7. A method of providing a book service based on a book image, which is performed by the apparatus of claim 1, the method comprising:
acquiring, by the acquisition unit, a book image from a user;
determining, by the determination unit, whether the user is a learning service user using a pre-designated learning service and determining whether the user has a purchase-related history associated with a target book corresponding to the book image at a pre-designated shopping mall; and
providing, by the provision unit, a book service associated with the target book when it is determined that the purchase-related history exists.
